(19) United States
(12) Patent Application Publication
(10) Pub. No.: US 2009/0031237 A1
(43) Pub. Date: Jan. 29, 2009

(54) DISPLAYING AND NAVIGATING THROUGH MULTIPLE APPLICATIONS

(75) Inventors: Per Jessen, Kobenhavn (DK); Romel Amineh, Kobenhavn (DK); Kevin McCarthy, Lyngby (DK); Vesa Huotari, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/828,690

(22) Filed: Jul. 26, 2007

(51) Int. Cl. G06F 3/048

(52) U.S. Cl. 715/768

(57) ABSTRACT

An apparatus for displaying layers generated by multiple applications is provided. Layers generated by one or more applications are presented on a display at particular levels of transparency such that a user may be able to simultaneously view the layers. The user can select one of the layers with which to interact by varying the respective levels of transparency such that one of the layers is less transparent and the other of the layers is more transparent. In this way, the user may manipulate the levels of transparency of the layers to navigate through multiple applications and access a desired application. Corresponding methods and computer program products are also provided.

### TECHNOLOGICAL FIELD

Embodiments of the present invention relate generally to communications technology and, more particularly, to displaying layers generated by multiple software applications using various levels of transparency.

### BACKGROUND

Multitasking is viewed by many as the epitome of efficiency and productivity. People are constantly striving to perform more tasks using fewer tools in less time. Thus, when it comes to using software applications such as on computers and mobile terminals, people want to have access to multiple active applications while being able to navigate through the active applications to focus on a particular application when necessary.

For example, the user of a mobile phone may have the ability to view downloaded movies on the display screen of the mobile phone. Although the user may not wish to have his movie-viewing experience interrupted, the user may be interested in certain correspondence, such as text messages, received from a particular individual. The user may thus find it desirable to simultaneously view the movie as it is playing and monitor incoming text messages to see if any are from the particular individual.

Thus, there is a need for a way to display layers generated by one or more applications simultaneously to a user without disrupting the user's access to the layer with which the user is interfacing at the time and while providing the user the ability to navigate from one layer to the other.

### BRIEF SUMMARY

An apparatus, method, and computer program product are therefore provided for displaying layers. Layers generated by one or more applications are presented on a display at particular levels of transparency such that a user may simultaneously view the layers. The user is able to select one of the layers with which to interact by varying the respective levels of transparency such that one of the layers is less transparent and the other(s) of the layers is more transparent.

In one exemplary embodiment, an apparatus for displaying layers is provided. The apparatus comprises a processor configured to present a first layer at a first level of transparency and a second layer at a second level of transparency. The processor is also configured to receive an input from a user varying the transparency of the first and second layers. In this way, the processor may be configured to decrease the transparency of one of the first and second layers and to increase the transparency of the other of the first and second layers in response to the input received.

The processor may be configured to present the second layer at a second level of transparency that is different from the first level of transparency. The processor may also be configured to present the layers in an overlapping configuration and to present the second layer without interrupting access of the user to the first layer. In some embodiments, the processor may be configured to present the first layer at the first level of transparency that is associated with the second level of transparency, such that an increase in the first level of transparency of the first layer results in a proportional decrease in the second level of transparency of the second layer.

The processor may be configured to present the first layer according to instructions provided through a first application and to present the second layer according to instructions provided through a second application. In some instances, the processor may be configured to present the first layer such that the first layer provides access to a first plurality of applications, and the processor may be configure to present the second layer such that the second layer provides access to a second plurality of applications. The processor may also be configured to receive input via a user input device selecting one of the first plurality of applications or one of the second plurality of applications when the first layer or the second layer, respectively, is at a predefined level of transparency.

In some cases, the apparatus may include a display in communication with the processor. The display may comprise a computer screen or a mobile terminal display. A user input device in communication with the processor may also be included. The user input device may comprise a scrollable input device configured to allow the user to cycle through the first and second applications by gradually varying the corresponding levels of transparency. The user input device may also include a haptic feedback device. Furthermore, the processor may be configured to present a third layer at a third level of transparency that is associated with the first and second levels of transparency.

In other exemplary embodiments, a method and a computer program product for displaying layers are provided. The method and computer program product display a first layer at a first level of transparency and display a second layer at a second level of transparency. Navigation between the first and second layers may be permitted by varying the first and second levels of transparency, wherein varying the first and second levels of transparency includes decreasing the transparency of one of the first and second layers and increasing the transparency of the other of the first and second layers.

The second layer may be displayed at a second level of transparency that is different from the first level of transparency. Permitting navigation between the first and second layers may include varying a first level of transparency that is associated with the second level of transparency, such that an increase in the first level of transparency of the first layer results in a proportional decrease in the second level of transparency of the second layer. Furthermore, the second layer may be overlaid onto at least a portion of the first layer such that both layers are visible in the overlaid portion. In some cases, the first layer may continue to be displayed such that the second layer is displayed without interrupting access of a user to the first layer.

In some embodiments, displaying the first layer includes displaying the first layer according to instructions provided through a first application, and displaying the second layer includes displaying the second layer according to instructions provided through a second application. Furthermore, a third layer may be displayed at a third level of transparency that is associated with the first and second levels of transparency. The first layer may be displayed such that the first layer provides access to a first plurality of applications, and the second layer may be displayed such that the second layer provides access to a second plurality of applications. Input may be received selecting one of the first plurality of applications or one of the second plurality of applications when the first layer or the second layer, respectively, is at a predefined level of transparency.

In another exemplary embodiment, an apparatus for displaying layers is provided that includes means for displaying a first layer at a first level of transparency and means for displaying second layer at a second level of transparency. The apparatus may also include means for receiving an input from a user varying the transparency of the first and second layers, wherein the transparency of one of the first and second layers is decreased and the transparency of the other of the first and second layers is increased in response to the input received.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is a schematic block diagram of an apparatus according to an exemplary embodiment of the present invention;

FIG. 4 is a schematic representation of a mobile terminal according to an exemplary embodiment of the present invention;

FIG. 5A is an illustration of a layer generated by a first application according to an exemplary embodiment of the present invention;

FIG. 5B is an illustration of a layer generated by a first application and a layer generated by a second application according to an exemplary embodiment of the present invention; and

FIG. 6 illustrates a flowchart according to an exemplary embodiment for displaying layers.

### DETAILED DESCRIPTION

Embodiments of the present inventions now will be described more fully hereinafter with reference to the accompanying drawings, in which some, but not all embodiments of the inventions are shown. Indeed, embodiments of these inventions may be embodied in many different forms and should not be construed as limited to the embodiments set forth herein; rather, these embodiments are provided so that this disclosure will satisfy applicable legal requirements. Like reference numerals refer to like elements throughout.

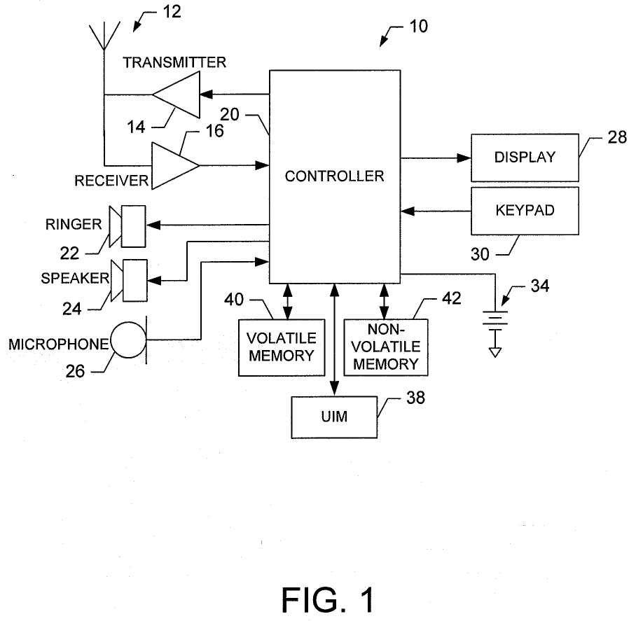

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, internet devices, mobile televisions, MP3 or other music players, cameras, laptop computers and other types of voice and text communications systems, can readily employ the present invention.

In addition, while several embodiments of the present invention will benefit a mobile terminal 10 as described below, embodiments of the present invention may also benefit and be practiced by other types of devices, i.e., fixed terminals. Moreover, embodiments of the present invention will be primarily described in conjunction with mobile communications applications. It should be understood, however, that embodiments of the present invention can be utilized in conjunction with a variety of other applications, both in the mobile communications industries and outside of the mobile communications industries. Accordingly, embodiments of the present invention should not be construed as being limited to applications in the mobile communications industry.

In one embodiment, however, the apparatus for displaying multiple layers is a mobile terminal 10. Although the mobile terminal may be embodied in different manners, the mobile terminal 10 of one embodiment includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA), third-generation wireless communication protocol Wideband Code Division Multiple Access (WCDMA), or future protocols.

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 of this embodiment also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 includes the conventional numeric (0-9) and related keys (#, *), and other keys used for operating the mobile terminal 10. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

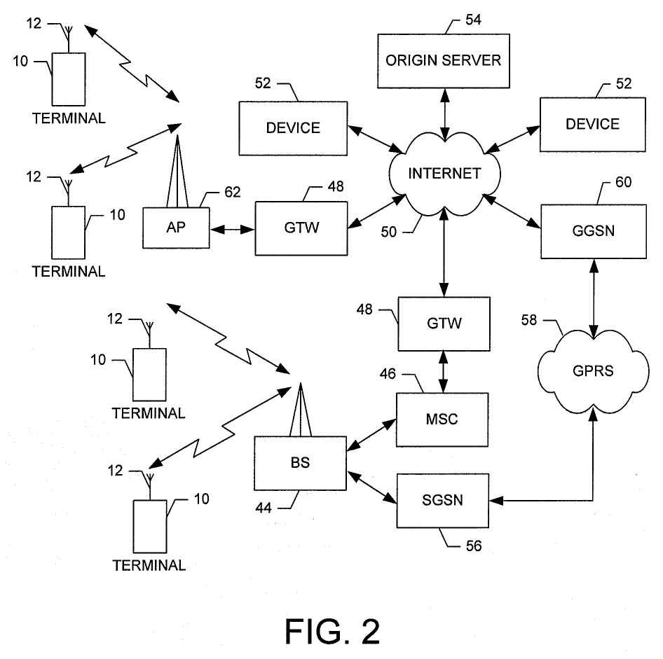

Referring now to FIG. 2, an illustration of one type of system that would benefit from and otherwise support embodiments of the present invention is provided. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a device 52 (two shown in FIG. 2), origin server 54 (one shown in FIG. 2), or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a device 52 and/or origin server 54 may be coupled to the mobile terminal 10 via the Internet 50, SGSN 56 and GGSN 60. In this regard, devices such as the device 52 and/or origin server 54 may communicate with the mobile terminal 10 across the SGSN 56, GPRS core network 58 and the GGSN 60. By directly or indirectly connecting mobile terminals 10 and the other devices (e.g., device 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the device 52, the origin server 54, and/or any of a number of other devices, to the Internet 50, the mobile terminals 10 can communicate with one another, the device, etc., to thereby carry out various functions of the mobile terminals 10, such as to transmit data, content or the like to, and/or receive content, data or the like from, the device 52. As used herein, the terms “data,” “content,” “information,” “signals” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to devices 52 across the Internet 50, the mobile terminal 10 and device 52 may be coupled to one another and communicate in accordance with, for example, RF, BT, IrDA or any of a number of different wireline or wireless communication techniques, including LAN, WLAN, WiMAX and/or UWB techniques. One or more of the devices 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the devices 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

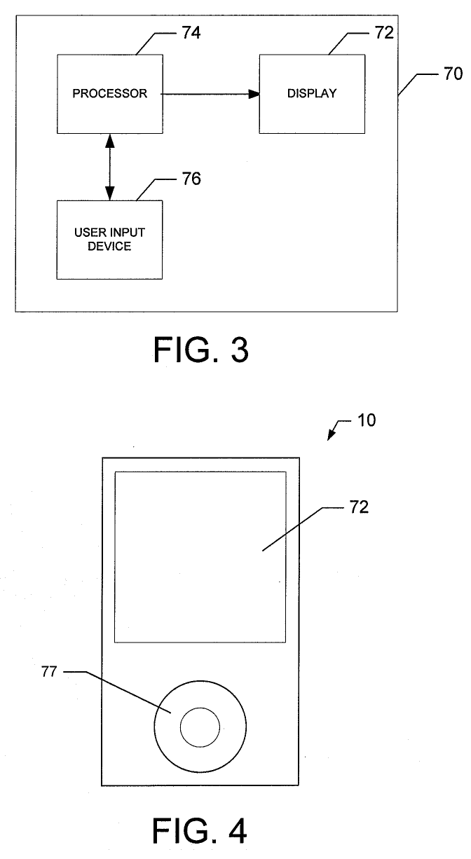

An exemplary embodiment of the invention will now be described with reference to FIG. 3, which shows an apparatus 70. The apparatus 70 may include, for example, the mobile terminal 10 of FIG. 1 or the device 52 depicted generally in FIG. 2. However, it should be noted that embodiments of the invention may also be employed with a variety of other devices, both mobile and fixed, and therefore, embodiments of the present invention should not be limited to use with devices such as the mobile terminal 10 of FIG. 1 or the devices 52 communicating via the network of FIG. 2.

In an exemplary embodiment, multiple layers generated by one or more software applications may be displayed on the apparatus 70 to be viewed simultaneously by a user of the apparatus 70. In this regard, a layer may include any visual presentation of information, such as text, bitmap picture, lossy jpg picture, or any combination of these or other representations of information. Information presented on a particular layer may be associated such that an action performed on the layer as a whole affects the presentation of all information on that layer. For example, some actions may affect the entire layer (i.e., all information presented on the layer), such as minimizing or maximizing the layer or changing the transparency of the layer as described below. Other actions, however, may only affect certain items of information presented on the layer without affecting the others, such as when a particular icon is selected from among several icons presented on the layer.

The user may view the layers in an overlapping configuration, where each layer is displayed at a particular level of transparency such that even in the portions of a display 72 containing two or more overlaid layers, each layer is discernable to the user. By varying the level of transparency of each layer, the user may be able to select an application with which to interact, as will be described in further detail below.

The apparatus 70 of FIG. 3 includes a processor 74, which may be, for example, the controller 20 of FIG. 1 or any other means configured to display a layer generated by an application at a particular level of transparency. The apparatus 70 may also include a display 72 of FIG. 1 in communication with the processor, or any other means upon which the processor may be configured to present the layers. For example, the display 72 may be a computer screen of a computer monitor in cases in which the apparatus 70 is a computer system or other type of computing device. Similarly, the display 72 may be a mobile terminal display 28, as shown in FIG. 1. The apparatus 70 may also include a user input device 76 in communication with the processor 74 and configured to receive an input from the user varying the transparency of the layers generated by the applications. For example, the user input device 76 may include a scrollable input device, a haptic feedback device (such as a dial or button that receives as an input the amount of pressure exerted upon it by the user's finger or hand), a keyboard, or a mouse, as well as other means for receiving input such that the user may select an application by varying the level of transparency associated with the layers, as will be described below.

Referring to FIGS. 3 and 4, the user may, for example, view multiple layers generated by one or more applications on the display 72. For example, a first application may be a media player that generates a layer allowing the user to view a movie on the display 72. A second application in this example may be an instant messaging application that generates a layer incoming messages received by the apparatus 70 from other mobile terminals 10, devices 52, and apparatuses 70. The processor 74 of the apparatus 70 shown in FIG. 3 may be configured to decrease the transparency of the layer generated by one of the first and second applications (e.g., the media player or the instant messaging application) and to correspondingly increase the transparency of the layer generated by the other of the applications in response to the input received by the user input device 76. In this way, the user may be able to select one of the applications by decreasing the level of transparency of the layer generated by the selected application (i.e., making the desired layer less transparent and thus more visible). The user may thus select, or choose, the application with which he wishes to interact (e.g., view and/or provide input) by varying the level of transparency associated with each displayed layer.

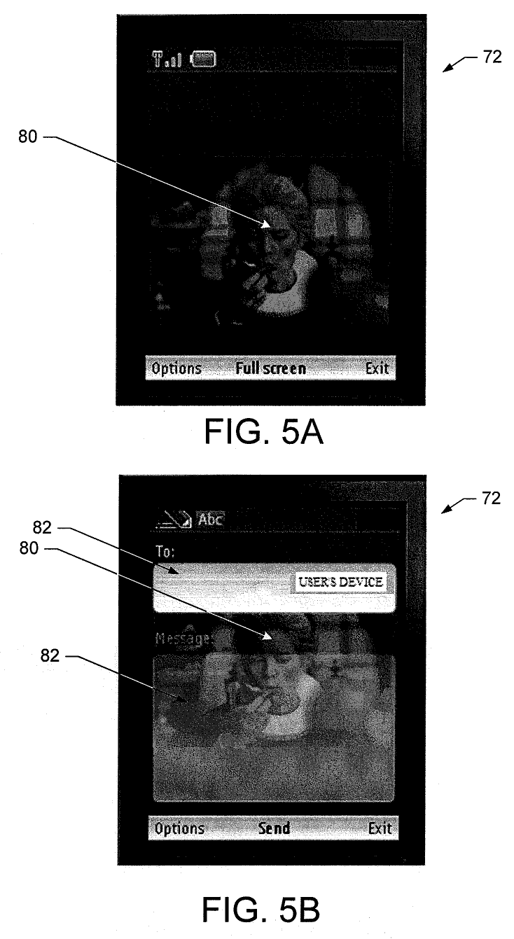

For example, the processor 74 may be configured to present the layer generated by the second application at a second level of transparency that is different from the first level of transparency. Referring to FIGS. 5A and 5B and the example above, the layer 80 of the movie generated by the media player application may be presented by the processor 74 upon the display 72 at a first level of transparency that is 0% transparent (i.e., not transparent at all), as shown in FIG. 5A. When a text message is received by the instant messaging application, the processor 74 may then present the layer 82 of the message at a second level of transparency that is different from the first level of transparency, as shown in FIG. 5B. In FIG. 5B, for example, the layer 82 of the message may be presented at a second level of transparency that is 25% transparent, such that the layer 80 of the movie may still be seen in the background through the layer 82 of the message. Thus, the processor 74 may be configured to present the layers 80, 82 in an overlapping configuration, as seen in FIG. 5B, such that neither layer 80, 82 need be reduced in size to allow the other layer to be presented. Rather, the transparency of one or the other of the layers may allow both layers to be viewed at the same time by the user, as depicted in FIG. 5B.

Furthermore, the processor 74 may be configured to present the layer 82 generated by the second application without interrupting access of the user to the layer 80 generated by the first application. In other words, the user in the above example may continue to view and experience the movie presented by the media player even though the instant messaging application is receiving and generating for a layer showing the text messages being received while the movie is playing. In this way, the user need not discontinue his viewing of the movie to check on the messages being received but may elect to ignore the messages to focus on the movie, as will be described further below.

In some embodiments, the processor 74 is configured to present a layer generated by the first application at the first level of transparency that is associated with the second level of transparency, such that a decrease in the first level of transparency of the layer generated by the first application results in a proportional increase in the second level of transparency of the layer generated by the second application. For example, a user of a computer may have a word processing application and an electronic mail application active at the same time. At one point, the user may be interacting with the word processing application, for example by typing words into a document presented upon the display 72. While the user is interacting with the word processing application, the document may be presented at a first level of transparency that is 0% transparent (i.e., not transparent) and the electronic mail may be presented at a second level of transparency that is 100% transparent (i.e., fully transparent), such that only the document of the word processing application and not the electronic mail of the electronic mail application may be viewed upon the display.

However, the user may later choose to interact with the electronic mail application (e.g., to check on any messages received or to send a message to someone). When the user decides to switch from the word processing application to the electronic mail application, the user may provide an input to the processor 74 to gradually vary the level of transparency of both layers (the document and the electronic mail) such that the document increases in transparency (i.e., becomes more transparent) and the electronic mail decreases in transparency (i.e., becomes less transparent). For example, the document, which may have started at a 0% level of transparency, may be gradually changed to be presented at a 100% level of transparency while at the same time the electronic mail may be changed from a 100% level of transparency to a 0% level of transparency.

However, because the level of transparency of the two layers may be associated with each other, as the level of transparency of the document changes from 0% to 25%, the level of transparency of the electronic mail may in turn change from 100% to 75%. Likewise, when the level of transparency of the document has reached 55% transparent, the level of transparency of the electronic mail may be at 45% transparent. Thus, as the user is varying the levels of transparency of the layers, both layers may be visible at a particular level of transparency (e.g., the one at a lower level of transparency appearing in the background and the one at a higher level of transparency appearing in the foreground) such that the user may not need to reach 100% and 0% transparency levels to check on the status of the second application (the electronic mail) but rather may be able to see that he has no new mail before the level of transparency of the electronic mail application has reached 0%. In this way, the user may return to the original levels of transparency (0% for the document and 100% for the electronic mail) and resume interaction with the word processing application.

It is to be understood that the level of transparency may be changed incrementally, in very small steps (such as 1%, 0.5%, or smaller). Furthermore, the level of transparency may be controlled automatically, such as by the processor 74 without considering input by the user, so that the change in transparency level appears smooth to the user, or the level may be controlled manually. In this regard, certain instructions may be available to the processor 74 such that the user may effect a change in the level of transparency from 0% or 100% to a predefined level with one keypress of the user input device 76.

Alternatively, referring again to the previous example, both the document and the electronic mail may be presented at a level of transparency that is 0% transparent (i.e., not transparent); however, the document with which the user is currently concerned may be in the foreground layer and the electronic mail may be in a layer behind the document, thereby hidden from view. When the user chooses to view or otherwise interact with the electronic mail, the level of transparency of the document (i.e., the foreground layer) may be changed from 0% transparency to 100% transparency (i.e., transparent) to allow the user to view the electronic mail (background layer), which was previously hidden.

The user may be able to vary the levels of transparency of the layers via various types of user input devices 76, as previously mentioned. For example, the user input device 76 may include a scrollable input device configured to allow the user to cycle through the first and second applications by gradually varying the levels of transparency. The user of a computer, for example, may be able to use Up or Down arrows on a keyboard or a scrolling dial on a mouse to gradually increase the level of transparency of one layer and/or to decrease the level of transparency of the other layer. Similarly, the user of a mobile terminal 10 may use other keys on a keyboard or keypad 30 (shown in FIG. 1) or a dedicated scrollable input device, such as the scrollable input device 77 shown in FIG. 4, to cycle through the applications by varying the levels of transparency of the layers generated by those applications. In some cases, for example, the user may use volume buttons on the apparatus 70 (such as a mobile phone) to increase or decrease the level of transparency.

For example, if the levels of transparency of the layers are associated, scrolling up on the scrollable input device 77 may serve to increase the level of transparency of the layer generated by one of the applications (e.g., a media player) from 0% to 50% to 100% transparent and at the same time decrease the level of transparency of the layer generated by the other of the applications (e.g., a messaging application) from 100% to 50% to 0%. In this way, the user may select one of the applications (in this example, the messaging application) by changing the level of transparency of the selected application from 100% transparent to 0% transparent, as previously described.

Furthermore, the processor 74 of FIG. 3 may be configured to present a layer generated by a third application (such as a gaming application) at a third level of transparency that is associated with the first and second levels of transparency. In this way, the user may be able to cycle through the layers generated by all three applications, for example using the scrollable input device 77 of FIG. 4, by gradually varying the level of transparency of the three layers such that each layer in turn reaches a level of transparency of 0% before once again increasing in transparency to allow another layer to reach 0% transparency. Thus, the user may select one of the three active applications by continuing to cycle through the applications until the desired application has achieved 0% transparency.

In some cases, the layers may be used to structure and organize the presentation and/or accessibility of various applications for the user. In this respect, each layer may not necessarily be associated with an active application but may instead provide access to multiple applications (e.g., by displaying icons representing each application), thereby allowing a user to navigate through several possible applications by navigating from one layer to the next. For example, an application grid may be organized into three layers—a first layer including media applications, a second layer including office applications (such as word processing and spreadsheet applications), and a third layer including gaming applications. The user may view the applications available on each layer by varying the level of transparency of the various layers and thereby navigating from one layer to the next. As one of the layers reaches a level of transparency of 0% (not transparent), the user may be enabled to select one of the applications provided on that particular layer (for example, by using the user input device to select an icon associated with the desired application). In this way, numerous applications may be organized and presented to the user in a clear and un-cluttered fashion.

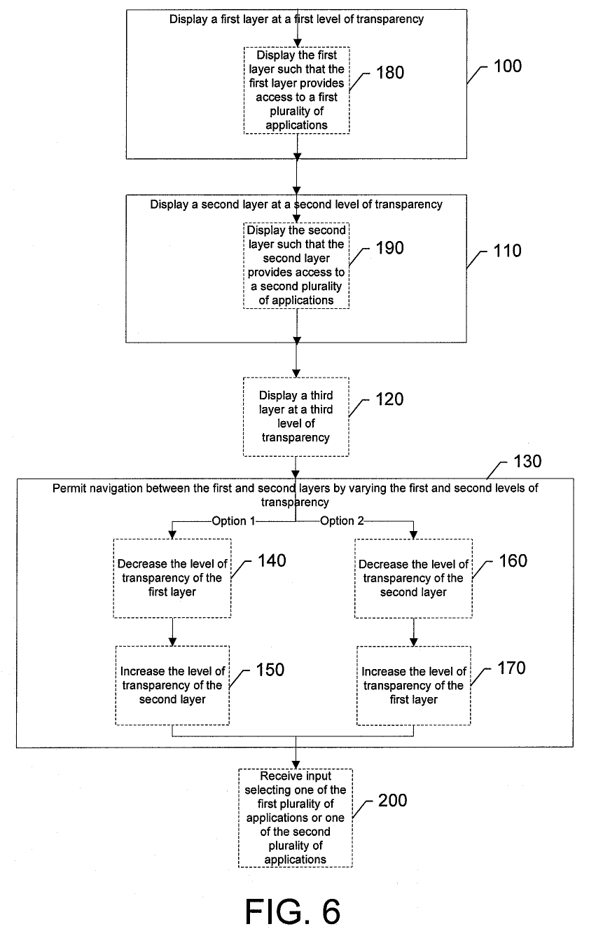

In other embodiments, a method for displaying and accessing layers generated by one or more applications is provided. Referring to FIG. 6, a first layer is initially displayed at a first level of transparency, and a second layer is also displayed at a second level of transparency. See FIG. 6, blocks 100, 110. For example, a first layer showing a movie generated by a media player application may be displayed at a level of transparency such as 0% transparent, and a second layer including a text message generated by a messaging application may be displayed at a level of transparency such as 50% transparent. Although the second layer is depicted as being displayed after the first layer in FIG. 6, the layers may be displayed in any order or they may be displayed simultaneously. For example, a layer may be displayed when the user activates a certain application, or a layer may be displayed when there is a change in the status of a particular application, such as when a message is received by the messaging application. Furthermore, other layers generated by the same or additional applications may also be displayed at various levels of transparency. For example, a third layer may be displayed at a third level of transparency that is associated with the first and second levels of transparency, as previously described. Block 120.

Navigation between the first and second layers may then be permitted by varying the first and second levels of transparency. Block 130. The transparency of one of the layers may be decreased while the transparency of the other layer may be increased (in any order or simultaneously). Blocks 140-170. For example, a user may change the transparency of one layer from 0% transparent to 25% transparent (e.g., using a scrollable input device as described above), which may in turn change the transparency of the other layer from 100% transparent to 75% transparent. In this way, as one layer is changed to a higher level of transparency, the level of transparency of the other layer may also be proportionally changed to a lower level of transparency.

In some cases, the first layer may be displayed at a second level of transparency that is different from the first level of transparency. Furthermore, the second layer may be overlaid onto at least a portion of the first layer such that both layers may be visible in the overlaid portion, as depicted in FIG. 5B and described above. Also, the first layer may continue to be displayed, and access of a user to the first layer may be uninterrupted as the second layer is displayed.

When the second layer is displayed, the level of transparency of the first layer may be increased and the level of transparency of the second layer may be decreased. The first layer may be displayed according to instructions provided through a first application and the second layer may be displayed according to instructions provided through a second application. Thus, for example, as a text message is received, the level of transparency of a word processing application may be increased from 0% transparent to 25% and the level of transparency of the text message may be decreased from 100% transparent to 75% transparent. In this way the user may be able to view both layers to determine with which application he should interact.

Furthermore, the user may select one of the first and second applications by varying the corresponding levels of transparency, as previously discussed. For example, the level of transparency of the layer generated by the selected application may be decreased (such as from 100% transparent to 0% transparent) and the level of transparency of the layer generated by the unselected application may be increased (such as from 0% transparent to 100% transparent). Thus, a user may select an application with which to interact by changing the level of transparency of the layer generated by the selected application to 0% transparent such that the user is able to fully view the layer.

In some embodiments, the first layer may be displayed such that the first layer provides access to a first plurality of applications, and the second layer may be displayed such that the second layer provides access to a second plurality of applications. Blocks 180, 190. For example, several media applications may be presented (such as in the form of icons) on the first layer, and several office applications may be presented on the second layer, as previously described. An input selecting one of the first plurality of applications (e.g., a media application) or one of the second plurality of applications (e.g., an office application) may then be received. Block 200.

Exemplary embodiments of the present invention have been described above with reference to block diagrams and flowchart illustrations of methods, apparatuses, and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus, such as the controller 20 (shown in FIG. 1) and/or the processor 74 (shown in FIG. 3), to function in a particular manner, such that the instructions stored in the computer-readable memory produce an article of manufacture including computer-readable instructions for implementing the function specified in the flowchart block or blocks illustrated in FIG. 6. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus comprising:
a processor configured to present a first layer at a first level of transparency and a second layer at a second level of transparency and configured to receive an input from a user varying the transparency of the first and second layers;
wherein the processor is configured to decrease the transparency of one of the first and second layers and to increase the transparency of the other of the first and second layers in response to the input received.

2. The apparatus of claim 1, wherein the processor is configured to present the second layer at a second level of transparency that is different from the first level of transparency.

3. The apparatus of claim 1, wherein the processor is configured to present the first layer at the first level of transparency that is associated with the second level of transparency, such that an increase in the first level of transparency of the first layer results in a proportional decrease in the second level of transparency of the second layer.

4. The apparatus of claim 1, wherein the processor is configured to present the first and second layers in an overlapping configuration.

5. The apparatus of claim 1, wherein the processor is configured to present the second layer without interrupting access of the user to the first layer.

6. The apparatus of claim 1, wherein the processor is configured to present the first layer according to instructions provided through a first application and to present the second layer according to instructions provided through a second application.

7. The apparatus of claim 1, wherein the processor is configured to present the first layer such that the first layer provides access to a first plurality of applications and to present the second layer such that the second layer provides access to a second plurality of applications.

8. The apparatus of claim 7, wherein the processor is configured to receive input via a user input device selecting one of the first plurality of applications or one of the second plurality of applications when the first layer or the second layer, respectively, is at a predefined level of transparency.

9. The apparatus of claim 1 further comprising a display in communication with the processor, wherein the display comprises a device selected from the group consisting of a computer screen and a mobile terminal display.

10. The apparatus of claim 1 further comprising a user input device in communication with the processor, wherein the user input device comprises a scrollable input device configured to allow the user to cycle through the first and second applications by gradually varying the corresponding levels of transparency.

11. The apparatus of claim 10, wherein the user input device comprises a haptic feedback device.

12. The apparatus of claim 1, wherein the processor is configured to present a third layer at a third level of transparency that is associated with the first and second levels of transparency.

13. A method comprising:
displaying a first layer at a first level of transparency;
displaying a second layer at a second level of transparency; and
permitting navigation between the first and second layers by varying the first and second levels of transparency;
wherein varying the first and second levels of transparency comprises decreasing the transparency of one of the first and second layers and increasing the transparency of the other of the first and second layers.

14. The method of claim 13, wherein displaying the second layer comprises displaying the second layer at a second level of transparency that is different from the first level of transparency.

15. The method of claim 13, wherein permitting navigation between the first and second layers comprises varying a first level of transparency that is associated with the second level of transparency, such that an increase in the first level of transparency of the first layer results in a proportional decrease in the second level of transparency of the second layer.

16. The method of claim 13, wherein displaying the second layer comprises overlaying the second layer onto at least a portion of the first layer such that both layers are visible in the overlaid portion.

17. The method of claim 13, wherein displaying the second layer comprises continuing to display the first layer without interrupting access of a user to the first layer.

18. The method of claim 13, wherein displaying the first layer comprises displaying the first layer according to instructions provided through a first application and wherein displaying the second layer comprises displaying the second layer according to instructions provided through a second application.

19. The method of claim 13 further comprising displaying a third layer at a third level of transparency that is associated with the first and second levels of transparency.

20. The method of claim 13, wherein displaying the first layer comprises displaying the first layer such that the first layer provides access to a first plurality of applications and wherein displaying the second layer comprises displaying the second layer such that the second layer provides access to a second plurality of applications.

21. The method of claim 20 further comprising receiving input selecting one of the first plurality of applications or one of the second plurality of applications when the first layer or the second layer, respectively, is at a predefined level of transparency.

22. A computer program product comprising at least one computer-readable storage medium having computer-readable program code portions stored therein, the computer-readable program code portions comprising:
a first executable portion for displaying a first layer at a first level of transparency;
a second executable portion for displaying a second layer at a second level of transparency; and
a third executable portion for permitting navigation between the first and second layers by varying the first and second levels of transparency, wherein varying the first and second levels of transparency comprises decreasing the transparency of one of the first and second layers and increasing the transparency of the other of the first and second layers.

23. The computer program product of claim 22, wherein the second executable portion is further configured for displaying the second layer at a second level of transparency that is different from the first level of transparency.

24. The computer program product of claim 22, wherein the third executable portion is further configured for varying a first level of transparency that is associated with the second level of transparency, such that an increase in the first level of transparency of the first layer results in a proportional decrease in the second level of transparency of the second layer.

25. The computer program product of claim 22, wherein the second executable portion is further configured for overlaying the second layer onto at least a portion of the first layer such that both layers are visible in the overlaid portion.

26. The computer program product of claim 22, wherein the second executable portion is further configured for allowing the continued display of the first layer without interrupting access of a user to the first layer.

27. The computer program product of claim 22, wherein the first executable portion is further configured for displaying the first layer according to instructions provided through a first application and wherein the second executable portion is further configured for displaying the second layer according to instructions provided through a second application.

28. The computer program product of claim 22 further comprising a fourth executable portion for displaying a third layer at a third level of transparency that is associated with the first and second levels of transparency.

29. The computer program product of claim 22, wherein the first executable portion is further configured for displaying the first layer such that the first layer provides access to a first plurality of applications and wherein the second executable portion is further configured for displaying the second layer such that the second layer provides access to a second plurality of applications.

30. The computer program product of claim 29 further comprising a fourth executable portion for receiving input selecting one of the first plurality of applications or one of the second plurality of applications when the first layer or the second layer, respectively, is at a predefined level of transparency.

31. An apparatus comprising:
means for displaying a first layer at a first level of transparency;
means for displaying a second layer at a second level of transparency; and
means for receiving an input from a user varying the transparency of the first and second layers, wherein the transparency of one of the first and second layers is decreased and the transparency of the other of the first and second layers is increased in response to the input received.
